(19) United States
(12) Patent Application Publication
(10) Pub. No.: US 2008/0276060 A1
(43) Pub. Date: Nov. 6, 2008

(54) Pre-Configured Partitions With Use-Rights Limitations

(76) Inventors: Erik Bostrom, Highlands Ranch, CO (US); Christie Melnychuk, Calgary (CA)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/743,137

(22) Filed: May 1, 2007

(51) Int. Cl. G06F 12/00

(52) U.S. Cl. 711/164

(57) ABSTRACT

A computer system comprising includes an inactive partition with a bootable operating system installed and a license manager for obtaining a license that allows the partition to be activated.

### BACKGROUND

Purchasers of computer systems who buy only enough hardware to meet current average demand often face costly interruptions when upgrading hardware to meet increased demands or vastly overprovision the server up front resulting in excess deployment cost. In a “limited-right-to-use” purchase model, a purchaser purchases a computer system with reserve computing power, but pays for only a subset of the installed hardware and software (e.g., an operating system) until the rest is required, e.g., by future increases in demand. Refinements of this business model 1) allow a user to make temporary use of the reserve capacity to handle spikes in demand, 2) allow use rights to migrate among resources to facilitate a reallocation of resources to workloads.

Once additional rights are obtained, the newly licensed hardware can be added to existing workloads to increase the performance of existing workloads or configured to define a new partition one which a new workload is to be run. In the latter case for example, the partition is configured, the new partition is connected to communications structures such as computer networks and storage array networks, an operating system is installed, and then one or more applications are installed.

Herein, related art is described to facilitate understanding of the invention. Related art labeled “prior art” is admitted prior art; related art not labeled “prior art” is not admitted prior art.

### BRIEF DESCRIPTION OF THE DRAWING

The figure depicts implementations/embodiments of the invention and not the invention itself.

FIG. 1 is a combination schematic diagram and flow chart in accordance with embodiments of the invention.

### DETAILED DESCRIPTION

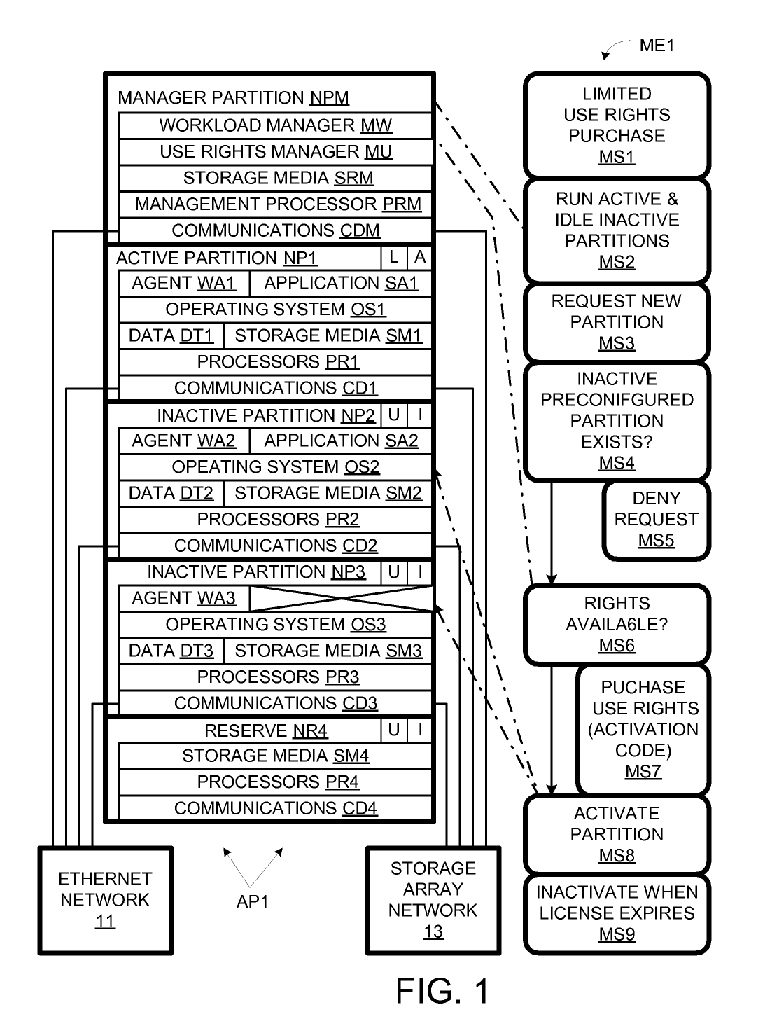

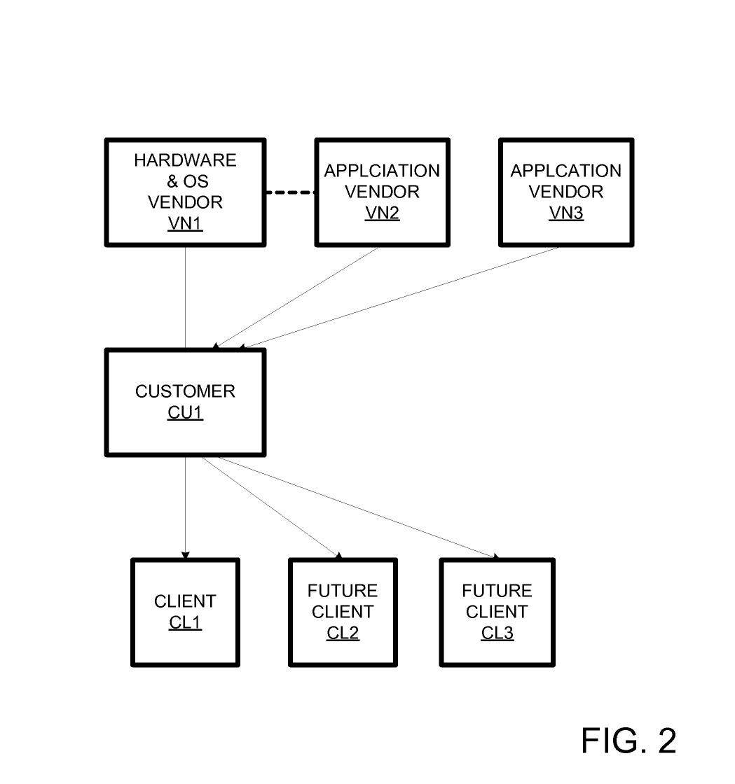

The present invention applies the limited-right-to-use business model to fully and partially configured partitions and stand alone servers. As shown in FIG. 1, a server AP1 includes a management partition NPM, an active user partition NP1, inactive partitions NP2 and NP3, and reserve hardware NR4. Each partition NPM, NP1, NP2, NP3 is connected to an Ethernet network 11 and a storage array network (SAN) 13. In other embodiments, the connections between partitions and networks is different, e.g., not all partitions need be connected to a SAN, multiple SANs can be involved, and multiple Ethernet and other protocol networks can be used.

Active partition NP1 includes processors PR1, computer-readable storage media SM1 (including memory and disk-based media), and communications devices CD1, such as a network interface card for connecting to Ethernet network 11 and a host bus adapter for connecting to storage array network 13. Storage media SM1 stores data DT1 and programs executable by processors PR1. The programs include operating system OS1, a management agent WA1, and an application SA1. The application can be a database, a web server, accounting software, etc. In FIG. 1, the indication “L” means the partition is “licensed” and the indication “A” means it is active.

Inactive partition NP2 includes processors PR2, storage media SM2, and communications devices CD2. Storage media SM2 stores data DT2, and programs including an operating system OS2, a management agent WA2, and an application SA2. Alternatively, some or all of this software can be stored externally and accessed using communications devices CD2, e.g., via SAN 13. The “U” indication indicates that the partition is not licensed and the “I” indicates “inactive”.

Inactive partition NP3 includes processors PR3, storage media SM3, and communications devices CD3. Storage media SM3, including volatile memory and non-volatile storage, stores data DT3, and programs including an operating system OS3, and a management agent WA3. Unlike inactive partition NP2, inactive partition NP3 does not have an application installed. Reasons for this difference are discussed below. As the U and I indicate, this partition NP3 is unlicensed and inactive.

Reserve NR4 includes processors PR4, media SM4, and communications devices CD4. These components are unlicensed and inactive. However, once they are licensed, they can be allocated to any active or inactive partition. Alternatively, some reserve components can be configured to define a new partition.

Inactive partitions NP2 and NP3 differ in that partition NP2 has an application SA2 installed while partition NP3 does not. This could be because the application to be run on inactive partition NP3 has not been determined. Even if the application to be run on partition NP3 were known, licensing considerations might preclude its installation on an inactive partition.

Management partition NPM comprises a workload manager MW, a use rights manager MU, storage media, e.g., flash memory, SRM, a management processor PRM, and communications devices CDM. In an alternative embodiment, a workload management function is distributed among active partition and is not located in a separate management partition.

FIG. 2 represents an enterprise scenario for system AP1, which belongs to customer CU1 subject to use-rights limitations. Vendor V1 is the source of the hardware for system AP1 and the operating system instances OS1, OS2, and OS3. Vendor V2 is the source for application V2. System vendor V1 and application vendor V2 have an arrangement that allows application to be activated when partition is activated. Of course, an application available from system vendor V1 would likely be available with a coordinated license. Alternatively, the license for licensed application SA1 might permit other instance so no value is wasted by leaving an instance on an inactive partition.

In one scenario, application SA1 on active partition NP1 and application SA2 on inactive partition NP2 are instances of the same application, e.g., a web hosting site. Active partition NP1 may be dedicated to one client CL1. When a new client CL2 signs on, customer CU1 pays vendor V2 for an activation code and partition NP2 is activated, application SA2 is then available to customer's new client CL2 without the need for configuring a partition and installing an application. Customer CU1 is thus more responsive to its clients than it would be if a new partition had to be configured after the client came onboard.

In the case of inactive partition NP3, no application is preinstalled, but the partition is otherwise pre-configured to the point operating system OS3 is installed. Installation of an application may be required when future client CL3 comes onboard requiring access to its own partition. On the other hand, any application can be installed; there is no requirement of a coordinated licensing arrangement for inactive partition NP3.

A method ME1 relating to system AP1 is flow charted in FIG. 1. At method segment MS1, customer purchases system AP1 with limited use rights. In the illustrated initial configuration of method segment MS2, system AP1 is run with one active partition NP1, while two unlicensed partitions are inactive NP2 and NP3. “Inactive” includes a “power off” state, as well as processor idle states. In the later case, a partition can be booted until the operating system and an application are loaded; the processors can be put in an idle state. This allows a nearly instant response to a request for an additional partition.

A new partition is requested at method segment MS3. This request may be made by an administrator via an Ethernet connection to communications devices CDM. The request could also be generated automatically, e.g. in accordance with a policy of workload manager MW. In response to the request, workload manage MW determines if a preconfigured partition exists at method segment MS4. If none exists, the requester is notified that the request is denied at method segment MS5. Alternatively, a procedure for licensing and configuring a new partition can be initiated.

If an inactive partition exists, use-rights manager determines whether or not rights are available for an inactive partition at method segment MS6. It may be that rights have been purchased but the partition is inactive for other reasons—e.g., to save power when it is not needed. Also, pooled rights may be available. Also, use rights might be available on a pay-as-you-go model. In another scenario, rights may be available provided another partition is inactivated on this or another system.

If rights are not available, use rights manager can imitate a procedure for obtaining the results, at method segment MS7. For example, an automated procedure might allow purchase of an activation code that can then allow an inactive partition to be activated. Also, the activation code can be purchased under control of an information technology (IT) administrator.

Once use rights have been obtained or if they are already available, the new partition can be activated at method segment MS8. This can involve elevating processors from an idle state to an active state, or powering on and booting the partition. Depending on the configuration of the inactive partition, additional software may or may not need to be installed. Note that the availability of hardware resources in reserved section NR4 allows the configuration of a formerly inactive partition to be changed and managed once it is licensed and active. If the license is temporary, workload manager WM can inactivate the partition when the license expires at method segment MS9. In an alternative embodiment, this capability is not provided.

The configuration of an inactive partition can vary. Some or all network connections can be in place. The partition hardware can be configured along with the operating system. Application software, a guest operating system running as a virtual machine on the host operating system, and other programs and data can be pre-installed or installed after activation.

The present invention applies to multi-station systems and single station systems; each station can correspond to a single partition or be divided into multiple partitions. Activation can be pursuant to a permanent activation, a temporary activation, or a reallocation involving a transfer of license rights and hardware resources from one workload to another. These and other variations upon and modifications to the illustrated embodiments are provided for by the present invention, the scope of which is defined buy the following claims.

What is claimed is:

1. A computer system comprising:
an inactive partition including a bootable operating system; and
a use rights manager for obtaining a licensee to run said partition; and
a workload manager for activating said partition once said license is obtained.

2. A computer system as recited in claim 1 further comprising
an active partition.

3. A computer system as recited in claim 2 wherein while said active partition is running a workload, said inactive partition is booted but idle.

4. A computer system as recited in claim 2 wherein while said active partition is running a workload, power is withheld from said inactive partition.

5. A computer system as recited in claim 1 wherein an operating system is installed on said inactive partition.

6. A computer system as recited in claim 5 wherein an application is installed on said inactive partition.

7. A computer system as recited in claim 1 wherein said inactive partition is connected to a network.

8. A business method comprising a vendor selling a computer system to a customer with use rights limits allowing use of a first partition and precluding use of a second partition until license rights are obtained for said partition, said second partition having a respective operating system instance installed.

9. A business method as recited in claim 8 further comprising said customer purchasing use rights for said second partition and activating said second partition.

10. A business method as recited in claim 9 wherein said second partition is connected to a network before said purchasing of said use rights.

11. A business method as recited in claim 9 further comprising installing an instance of an operating system on said second partition prior to said purchasing.

12. A business method as recited in claim 11 further comprising installing an application program on said partition prior to said purchasing.

13. A business method as recited in claim 11 further comprising performing an original installation of an application on said second partition after activating said second partition.

14. A business method as recited in claim 11 further comprising, while said first partition is active and before said purchasing of said use rights, maintaining said second partition in an idle power on state.

15. Computer-readable media comprising:
computer-executable instructions for receiving a request to activate a server partition, for determining whether a license has been obtained for said server partition, and for activating said partition provided said license has been obtained.

16. Media as recited in claim 15 wherein said instructions are also for purchasing said license if it has not been previously obtained.

17. Media as recited in claim 15 wherein said instructions activate said partition by causing power to be supplied to it.

18. Media as recited in claim 15 wherein said instructions activate said partition at least in part by elevating one or more processors from an idle state to an active state.

19. Media as recited in claim 15 wherein said instructions activate said partition so that a pre-installed operating system controls hardware of said partition.

20. Media as recited in claim 15 wherein said instructions inactivate said partition when said license expires.
